(19) United States
(12) Patent Application Publication
(10) Pub. No.: US 2005/0233901 A1
(43) Pub. Date: Oct. 20, 2005

(54) Thermal transfer recording material

(76) Inventors: Hiroki Nakane, Tokyo (JP); Satoshi Okano, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/099,813

(22) Filed: Apr. 5, 2005

(30) Foreign Application Priority Data
Apr. 14, 2004 (JP) JP2004-118719

(51) Int. Cl. B41M 5/20

(52) U.S. Cl. 503/201

(57) ABSTRACT

A thermal transfer recording material is disclosed, comprising a thermal transfer sheet having a dye layer containing a dye on at least one side of a substrate sheet and an image receiving sheet having a dye receiving layer on at least one side of a substrate and the dye of the dye layer is transferable to the dye receiving layer when the dye layer and the dye receiving layer are superimposed on each other and heated by a heating device, wherein the dye receiving layer comprises a metal agent and a binder resin and further comprises a metal species selected from the group consisting of an alkaline earth metal (II), B(III), Al(III), Ga(III), Zr(IV), Ag(I), Co(II), Cu(II) and Zn(II).

This application claims priority from Japanese Patent Application No. JP2004-118719 filed on Apr. 14, 2004, which is incorporated hereinto by reference.

### FIELD OF THE INVENTION

The present invention relates to novel thermal transfer recording materials exhibiting enhanced transfer image densities and superior light fastness.

### BACKGROUND OF THE INVENTION

There have been known color or monochromatic imaging technologies in which an ink sheet containing a thermally diffusible dye capable of diffusion transfer upon heating is placed to face the dye receiving layer of an image receiving sheet, after which the thermally diffusible dye is allowed to be imagewise transferred to the dye receiving layer by heat-printing means such as thermal heads or lasers to form an image (employing a so-called thermal dye transfer system). Such a thermal transfer system enables one to achieve image formation using digital data without using processing solutions such as a developer solution. This thermal transfer system is recognized as a method for forming high quality images equal to those of silver salt photography.

However, the thus obtained images were proved to have shortcomings such that the image storage stability or fastness was inferior to conventional silver salt photography.

Specifically, the following matters are cited:
(1) image fading or bleeding is caused by light or heat, aerial oxygen, or moisture during storage over a long period of time (light stability and heat stability),
(2) when brought into contact with substances exhibiting relative high dying affinity, such as a photoalbum or clear file, or plastic erasers, or plasticizer-containing materials, dyes are reversely transferred or images bleed out (plasticizer resistance),
(3) when water, juice, wine or coffee is dropped onto formed images and is wiped therefrom, dissolved dyes are also wiped off (water resistance and solvent resistance),
(4) when touched with a finger, the touched portion is discolored due to sebum (sebum resistance),
(5) when rubbed with eraser, image portions are removed (abrasion resistance), and
(6) when converted by using commercially available laminating material, specifically, cold laminate material convertible at a relative low temperature, dyes diffuse into the laminating material, causing bleeding of images (laminate suitability).

Dyes used in conventional silver halide photography are protected with high boiling solvents or ultraviolet absorbents. On the contrary, dyes used in thermal transfer recording material are mainly dispersed in a binder and tend to be directly influenced by an external environment.

There were proposed, as a means for improving the foregoing disadvantages, image forming methods by employing so-called reactive dyes in which a compound contained in the dye layer is allowed to react with a compound in the dye receiving layer through thermal transfer. Herein, when the compound contained in the dye layer and the compound in the dye receiving layer are defined as a dye precursor and a dye fixer, respectively, and JP-A No. 9-327976 (hereinafter, the term, JP-A refers to Japanese Patent Application Publication), U.S. Pat. Nos. 4,880,769 and 5,534,479, for example, proposed that using a deprotonated cationic dye as a dye precursor and an organic polymer or oligomer capable of protonating the cationic dye as a dye fixer, the cationic dye was protonated again to achieve image formation. JP-A No. 5-221151 proposed an image forming method in which a reactive group containing a dye with a specific structure as a dye precursor and an active hydrogen compound as a dye fixer were used to perform thermal transfer to form an image.

Further, there was proposed an image forming method in which a chelatable, thermally diffusible dye and a metal ion-containing compound are used as a dye precursor and a dye fixer, respectively are thermally transferred and reacted to form a metal chelate, as disclosed in JP-A Nos. JP-A Nos. 59-78893, 59-109394 and 60-2398. The thus formed image hardly caused dye fading or bleeding even when an image receiving material having the image thereon is allowed to stand under high temperature and high humidity over a long period of time, and also exhibited superior light fastness to images formed by conventional thermally diffusible dyes. However, reaction of a dye and a dye fixer was not completed in high image density areas, producing problems that the remaining unreacted dye caused hue change with the elapse of time.

To overcome the foregoing problems, an increased addition of a dye fixer into the dye receiving layer resulted in enhanced reactivity but produced such a problem that the colored dye fixer resulted in coloring of the white background. There was also proposed another method in which transferred images were reheated, as disclosed in JP-A No. 11-70746, but this method produced the problems that when reheating is performed via a dye layer containing no dye between the thermal head and the image, the imaging dye is reversely diffused into the dye layer, resulting in decreased density.

There was also disclosed a method, for example, in JP-A No. 2001-246845 in which a protective layer transfer sheet having a thermally transferable protective layer was superposed on the image forming side of an image receiving sheet and the protective layer was transferred by using a heating means, such as a thermal head or a heating roller to form a protective layer on the imaging surface. The protective layer formed on the images resulted in enhanced physical resistances of the images, such as friction resistance, water resistance, solvent resistance and sebum resistance. However, reduction of a dye fixer in the dye receiving layer was required to allow the protective layer to adhere onto the dye receiving layer, thereby resulting in lowered reactivity of the dye with the dye fixer. To overcome the foregoing, increasing transfer energy at the time of transferring a protective layer resulted in a thermally deteriorated protective layer, leading to unsuitable granular appearance or yellowing of the image surface.

There was also disclosed (for example, in JP-A No. 6-267936) a method in which a thermal transfer image receiving sheet containing a specific ultraviolet absorbent and a hindered phenol type antioxidant were employed to enhance light fastness of the dye images. However, this method was proved to necessitate addition of a large amount of such a hindered phenol type antioxidant to achieve sufficiently enhanced light fastness, producing problems such as image bleeding or peeling. Furthermore, improvement in light fastness of mixed color images such as a gray image was insufficient and further improvement is desired.

### SUMMARY OF THE INVENTION

The present invention was accomplished in light of the foregoing problems. Thus, it is an object of the invention to provide a thermal transfer recording material exhibiting superior light fastness, specifically in color mixing such as graying and a sufficient transfer density.

One aspect of the invention is directed to a thermal transfer recording material comprising a thermal transfer sheet having a dye layer containing a dye on at least one side of a substrate sheet and a thermal transfer image receiving sheet having a dye receiving layer on at least one side of a substrate wherein when the dye layer and the dye receiving layer are superimposed on each other and heated through a heating device, the dye of the dye layer is transferable to the dye receiving layer, and wherein the dye receiving layer comprises a mold releasing agent and a binder resin and further comprises a metal species selected from the group consisting of an alkaline earth metal(II), B(III), Al(III), Ga(III), Zr(IV), Ag(I), Co(II), Cu(II) and Zn(II).

Another aspect of the invention is directed to a thermal transfer recording material comprising a thermal transfer sheet having a dye layer containing a chelatable dye on at least a part of a support and a thermal transfer image receiving sheet having a dye receiving layer containing a compound containing a metal ion capable of forming a chelate compound upon reaction with the chelatable dye on a substrate wherein when the dye layer and the dye receiving layer are superposed with each other and heated through a heating device, the chelatable dye of the dye layer is transferable to the dye receiving layer, and wherein the dye receiving layer comprises the metal ion-containing compound and a metal species selected from the group consisting of an alkaline earth metal(II), B(III), Al(III), Ga(III), Zr(IV), Ag(I), Co(II), Cu(II), Zn(II) and Ni(II).

Further, another aspect of the invention is directed to an image forming method of a thermal transfer recording material as described above comprising the steps of: (a) superimposing the thermal transfer sheet onto the image receiving sheet so that the dye layer and the dye receiving layer face each other and (b) imagewise heating the thermal transfer sheet by a heating device based on an image recording signal to transfer the dye from the thermal transfer sheet to the image receiving sheet to form an image.

### BRIEF EXPLANATION OF DRAWINGS

FIG. 1(a) and FIG. 1(b) illustrate sectional views of a thermal transfer sheet and a thermal transfer image receiving sheet, respectively.

FIG. 2 is a sectional view showing sequential supply of the respective dye layers and a post-heat treatment region in a thermal transfer sheet.

### DETAILED DESCRIPTION OF THE INVENTION

The thermal transfer recording material of this invention comprises a thermal transfer sheet having a dye layer containing a dye on at least one side of a substrate sheet and an image receiving sheet having a dye receiving layer on at least one side of a substrate wherein the dye of the dye layer is transferable to the dye receiving layer when the dye layer and the dye receiving layer are superimposed on each other and heated by a heating device, and wherein the dye receiving layer comprises a mold releasing agent and a binder resin and further comprises a metal species selected from the group consisting of an alkaline earth metal(II), B(III), Al(III), Ga(III), Zr(IV), Ag(I), Co(II), Cu(II) and Zn(II).

In the invention, the metal species is a compound including, as a constituent, at least one metal selected from the group consisting of an alkaline earth metal(II), B(III), Al(III), Ga(III), Zr(IV), Ag(I), Co(II), Cu(II) and Zn(II).

Examples of an alkaline metal include Mg(II), Ca(II), Sr(II) and Ba(II). A metal species is selected from an alkaline earth metal(II), B(III), Al(III), Ga(III), Zr(IV), Ag(I), Co(II), Cu(II) and Zn(II), and a metal species is preferably selected from Mg(II), Al(II), Cu(II) and Zn(II), thereby leading to further enhanced light fastness and a sufficient transfer density.

The foregoing metal species in the dye receiving layer is preferably in the form of a metal salt of an organic acid (or an organic acid metal salt), a metal alkoxide (also called a metal alcoholate) or an organic metal complex having at least a coordination bond with an oxygen atom, whereby enhanced light fastness and a sufficient transfer density are achieved. More preferably, the metal species in the dye receiving layer is in the form of an organic acid metal salt, and still more preferably a fatty acid metal salt. When a metal species in the dye receiving layer is in the form of a metal salt of a fatty acid, the fatty acid preferably has 18 or fewer carbon atoms in terms of solubility in the dye receiving layer. A fatty acid having 8 or fewer carbon atoms may be a saturated fatty acid or an unsaturated fatty acid and the carbon chain may be straight, branched or cyclic.

Organic acids usable in this invention are those which contain a functional group such as a carboxylic acid, dicarboxylic acid, sulfonic acid and phenol and specific examples thereof include acetic acid, oxalic acid, tartaric acid, and benzoic acid.

Examples of a fatty acid having 18 or less carbon atoms include formic acid, acetic acid, propionic acid, butyric acid, valeric acid, caproic acid, enathic acid, caprylic acid, pelargonic acid, decanoic acid, undecylic acid, lauric acid, tridecylic acid, mytistic acid, pentadecylic acid, palmitic acid, heptadecylic acid, stearic acid, acrylic acid, crotonic acid, isocrotonic acid, undecylenic acid, oleic acid, elaidic acid, sorbic acid, linolic acid, linolenic acid, propiolic acid and stearolic acid.

The metal alkoxide usable in the invention is a reaction product of the foregoing metals with alcohols such as ethyl alcohol isopropyl alcohol or butyl alcohol. Examples thereof include aluminum isopropyloxide and aluminum butyloxide (or aluminum butyrate).

The ratio of the content (a) of a metal salt of an organic acid (or an organic acid metal salt), a metal alkoxide or an organic metal complex having at least a coordination bond with an oxygen atom is contained in the dye receiving layer to the content (b) of a binder resin contained in the dye receiving layer (a/b) is preferably 1.0 or less. A content (a/b) of more than 1.0, which often results in a deteriorated membrane state such as peeling, making it difficult to achieve normal printing, is not preferable. Although some commercially available metal salts have a metal content of about 10%, the content of a metal salt of an organic acid (or an organic acid metal salt), a metal alkoxide or an organic metal complex having at least a coordination bond with an oxygen atom refers to a content of effective metal salts which is calculated from a metal content.

In one embodiment of the invention, the thermal transfer recording material comprises a thermal transfer sheet having a dye layer containing a dye capable of forming a chelate (i.e., chelate dye) on at least a part of a support and a thermal transfer image receiving sheet having a dye receiving layer containing a compound containing a metal ion capable of forming a chelate compound upon reaction with the chelatable dye on a substrate wherein when the dye layer and the dye receiving layer are superposed with each other and heated through a heating device, the chelatable dye of the dye layer is transferable to the dye receiving layer, and wherein the dye receiving layer comprises the metal ion-containing compound and a metal species selected from the group consisting of an alkaline earth metal(II), B(III), Al(III), Ga(III), Zr(IV), Ag(I), Co(II), Cu(II), Zn(II) and Ni(II).

Examples of an alkaline metal (II) include Mg(II), Ca(II), Sr(II) and Ba(II). A metal species is selected from an alkaline earth metal(II), B(III), Al(III), Ga(III), Zr(IV), Ag(I), Co(II), Cu(II), Zn(II) and Ni(II), and a metal species selected from Mg(II), Al(II), Cu(II), Zn(II) and Ni(II) is preferred, thereby leading to further enhanced light fastness and a sufficient transfer density.

The foregoing metal species in the dye receiving layer is preferably in the form of a metal salt of an organic acid (or an organic acid metal salt), a metal alkoxide or an organic metal complex having at least a coordination bond with an oxygen atom, whereby enhanced light fastness and a sufficient transfer density are achieved. More preferably, the metal species in the dye receiving layer is in the form of an organic acid metal salt, and still more preferably a fatty acid metal salt. When a metal species in the dye receiving layer is in the form of a metal salt of a fatty acid, the fatty acid preferably has 18 or fewer carbon atoms in terms of solubility in the dye receiving layer. A fatty acid having 8 or fewer carbon atoms may be a saturated fatty acid or an unsaturated fatty acid and the carbon chain may be straight, branched or cyclic.

In one preferred embodiment of this invention, the dye receiving layer contains a metal ion-containing compound (hereinafter, also denoted as a metal source), which is capable of forming a chelate compound upon reaction with a chelate dye. Metal sources include inorganic or organic salts or complexes of metal ions, and organic metal complexes are preferred. Metals include monovalent or polyvalent metals selected from groups I-VIII of the periodical table, and of these, Al, Co, Cr, Cu, Fe, Mg, Mn, Mo, Ni, Sn, Ti and Zn are preferred and Ni, Cu, Cr, Co and Zn are more preferred.

Specific examples of a metal source include salts of metal ions such as Ni⁺², Cu⁺², Cr⁺², Co⁺² or Zn⁺², and fatty acids or aromatic carboxylic acids such as acetic acid and stearic acid, or benzoic acid and salicylic acid. A complex represented by the following formula (I), which can be stably incorporated into the dye receiving layer and which is substantially colorless, is specifically preferred:
[M(Q₁)ₓ(Q₂)_{y}(Q₃)_{z}]^{p+}(L⁻)ₚ formula (I)
wherein M is a metal ion (preferably, Ni⁺², Cu⁺², Cr⁺², Co⁺² or Zn⁺²); Q₁, Q₂ and Q₃ are each a compound capable of forming a coordination bond with the metal ion of M (hereinafter, also denoted as a ligand compound), which may be the same or different and such a ligand compound can be selected from ligand compounds described, for example, in “Chelate Kagaku (5)” [Chelate Science (5), published by Nankodo]; L⁻ is an organic anion such as tetraphenylborate anion or alkylbenzenesulfonate anion; x is an integer of 1, 2 or 3, y is 0, 1 or 2, and z is 0 or 1 and these x, y and z, depending on a complex of the foregoing formula being four-coordinate or six-coordinate, are determined by the number of ligands of Q₁, Q₂ and Q₃; p is 1 or 2. Specific examples of such a metal source include those described in U.S. Pat. No. 4,987,049 and compound 1 to 51 described in JP-A No. 10-67181.

A metal source is preferably contained in an amount of 5% to 80% by weight (more preferably 10% to 70%), based on the weight of a binder contained in the dye receiving layer. The metal source content is usually 0.5 to 20 g/m², and preferably 1 to 15 g/m².

The ratio of the content (a) of a metal salt of an organic acid (or an organic acid metal salt), a metal alkoxide or an organic metal complex having at least a coordination bond with an oxygen atom to the content (b) of a binder resin contained in the dye receiving layer, i.e., a/b is preferably 1.0 or less. A content ratio (a/b) of more than 1.0, which often results in a deteriorated membrane state such as peeling, making it difficult to achieve normal printing, is to be avoided. Although some commercially available metal salts have a metal content of about 10%, the content of an organic acid metal salt, a metal alkoxide or an organic metal complex having at least a coordination bond with an oxygen atom refers to a content of effective metal salts which is calculated from a metal content.

The ratio of the molar content (c) of a metal species of the dye receiving layer to the molar content (d) of a metal ion-containing compound capable of forming a chelate compound upon reaction, i.e., c/d is preferably from 0.001 to 0.250. A c/d of less than 0.001 cannot display advantageous effects of this invention. When c/d is more than 0.250, chelation between a metal species and a chelate dye is caused, resulting in prints with non-negligibly varied hue. Accordingly, the ratio of c/d is more preferably from 0.001 to 0.150, and still more preferably from 0.001 to 0.100.

In one preferred embodiment of the thermal transfer recording material of this invention, a metal species meets the requirement that when the metal atom and ethylenediamine form a (1:2)-complex at an ionic strength of 0.1 mol/l and 25° C., an overall stability constant (β) falls within the following range:
4.5≦−logβ≦20.

A value of −logβ of more than 20 results in non-negligible change in hue of printing material, caused by chelation of a metal species and a chelate dye, and of course, such hue change is to be avoided. Thus, chelate formation of the metal species with a chelate dye is not preferred. More preferably, the overall stability constant (β) falls within the the range of 4.5≦−logβ≦20.

In one preferred embodiment of the thermal transfer recording material of this invention, a central metal included in a chelatable metal ion-containing compound meets the requirement that when the central metal and ethylenediamine form a (1:2)-complex at an ionic strength of 0.1 mol/l and 25° C., the overall stability constant (β) falls within the following range:
10≦−logβ≦20.

When the value of −logβ is less than 10, the foregoing metal is no longer a central metal and non-negligible change in hue of printing material is caused by chelation of the metal species and a chelate dye, and such hue change is not suitable.

In one preferred embodiment of this invention, a thermal transfer recording material comprises a thermal transfer sheet having a dye layer containing a chelatable dye on a support and a thermal transfer image receiving sheet having a dye receiving layer containing a compound containing a metal ion capable of forming a chelate compound upon reaction with the chelatable dye on a substrate wherein the dye layer and the dye receiving layer are superposed on each other and the chelatable dye of the dye layer is transferable to the dye receiving layer through a heating device, wherein the dye receiving layer is obtained by coating a coating solution of the dye receiving layer at a pH of 1 to 5. Any means to control the pH value of the coating solution within the range of from 1 to 5 is applicable and, for example, organic acids such as acetic acid may be added.

In one preferred embodiment of this invention, a thermal transfer recording material comprises a thermal transfer sheet having a dye layer containing a chelatable dye on a support and a thermal transfer image receiving sheet having a dye receiving layer containing a compound containing a metal ion capable of forming a chelate compound upon reaction with the chelatable dye on a substrate wherein the dye layer and the dye receiving layer are superposed on each other and the chelatable dye of the dye layer is transferable to the dye receiving layer through a heating device, wherein the dye receiving layer contains SO₄²⁻, SCN⁻, CH₃CO⁻, F⁻ or Cl⁻. The foregoing anions may be present in any form in the dye receiving layer.

When the dye receiving layer contains at least one of SO₄²⁻, SCN⁻, CH₃CO⁻, F⁻ or Cl⁻, the foregoing anion may be contained in any form in the dye receiving layer. The anion may be added in any form. For example, it may be added as a counter-anion for a metal source or as an organic compound containing the anion. The anion is added preferably in an amount of 0.01 to 2.0 times the molar number of the metal source.

The thermal transfer recording material of this invention is composed of a thermal transfer sheet having a dye layer on at least one side of a substrate sheet and a thermal transfer image receiving sheet having a dye receiving layer on at least one side of a substrate.

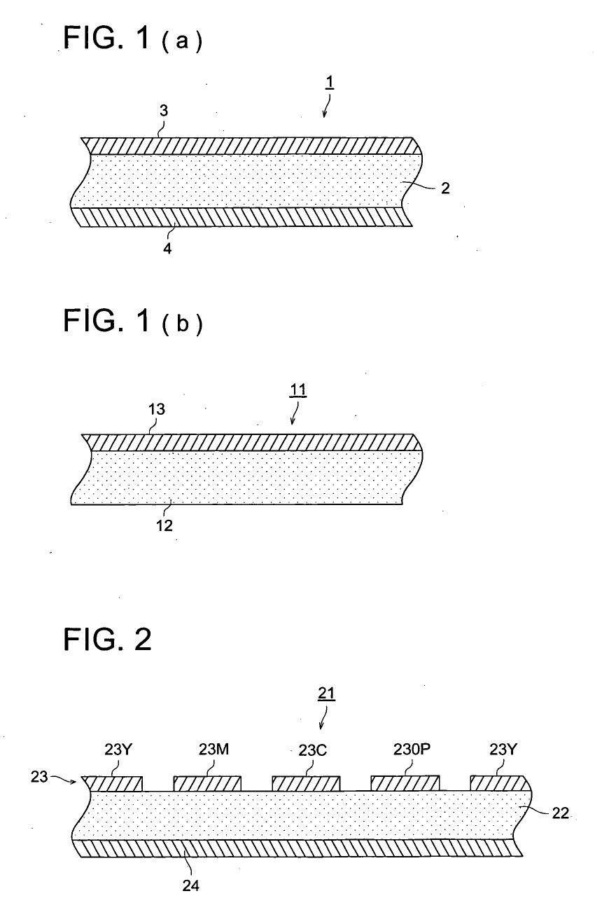

FIG. 1(a) and FIG. 1(b) illustrate sectional views of a thermal transfer sheet and a thermal transfer image receiving sheet. FIG. 1(a) is a sectional view of a typical constitution of a thermal transfer sheet of this invention, in which a thermal transfer sheet (1) is provided with a dye layer (3) on one side of a substrate sheet (2) and a heat-resistant slipping layer (4) on the other side of the substrate sheet (2). FIG. 1(b) is a sectional view showing a typical constitution of a thermal transfer image receiving sheet relating to this invention, and a thermal transfer image receiving sheet (11) has a dye receiving layer (13) in one side of substrate sheet (12).

### Thermal Transfer Sheet

Substrate Sheet

Material known as a substrate sheet of conventional thermal transfer sheet is also usable as a substrate sheet of a thermal transfer sheet of this invention. Specific examples of a preferred substrate sheet include thin paper such as glassine paper, condenser paper and paraffin paper, and stretched or unstretched plastic film of polyethylene terephthalate, polyethylene naphthalate, polybutylene terephthalate, polyphenylene sulfide, polyether ketone, highly heat-resistant polyester such as polyether sulfone, polypropylene, fluororesin, polycarbonate, cellulose acetate, polyethylene derivatives, polyvinyl chloride, polyvinilidene chloride, poystyrene, polyamide, polyimide, polymethylpentene, and ionomer, and laminated forms of the foregoing. The thickness of a substrate sheet, which is chosen in accordance with the material so as to optimize strength and heat resistance, is preferably from 1 to 100 μm.

The surface of a substrate sheet may be subjected to a primer treatment or a corona discharge treatment when adherence to the dye layer formed on the surface of a substrate sheet is poor.

Dye Layer and Dye

The dye layer constituting a thermal transfer sheet of this invention is a thermally sublimating colorant layer containing at least one dye and a binder. Dyes contained in the dye layer may be used singly or in combinations of them.

Next, dyes usable in this invention will be described. The dye including region used in the thermal transfer sheet may be a region including at least two dyes differing in color. For example, in one embodiment, the dye including region is comprised of a region including a yellow dye, a region including a magenta dye and a region including a cyan dye; in another embodiment, the dye including region is comprised of a dye layer including a black dye and next to the region, a region including no dye is formed; in another embodiment, the dye including region is comprised of a region including a yellow dye, a region including a magenta dye, a region including a cyan dye and a region including a black dye, and next to these regions, a region including no dye is formed.

Dyes usable in the thermally sublimating colorant layer include those used in thermal transfer sheet of a commonly known heat-sensitive sublimation thermal transfer system, such as azo type, azomethine type, methine type, anthraquinone type, quinophthalone type, and naphthoquinone type dyes. Specific examples yellow dyes such as phorone brilliant yellow 6GL and pTY-52, and macrolex yellow 6G; red dyes such as MS red G, macrolex red violet R, ceresred 7B, samarone red HBSL and SK rubin SEGL; and blue dyes such as cayaset blue 714, wacsoline blue, phorone brilliant blue S-R, MS blue 100 and dite blue No. 1.

Any thermally transferable dye is usable as a chelatable, thermally diffusible dye and various types of commonly known compounds may be optimally chosen and used. Examples thereof include cyan, magenta and yellow dyes described in JP-A Nos. 59-78893, 59-109349, 4-94974 and 4-07894 and U.S. Pat. No. 2,856,225.

Chelating cyan dyes include, for example, a compound represented by the following formula (1):

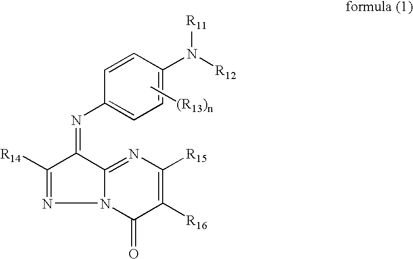

In the foregoing formula (1), R₁₁ and R₁₂ are each a substituted or unsubstituted aliphatic group and R₁₁ and R₁₂ may be the same or different. Examples of an aliphatic group include an alkyl group, cycloalkyl group, alkenyl group and alkynyl group. Examples of an alkyl group include methyl, ethyl, propyl and iso-propyl, and the alkyl group may be substituted by a substituent. Examples of the substituent include an alkyl group (e.g., methyl, ethyl, I-propyl, t-butyl, n-dodecyl, 1-hexyl, nonyl), cycloalkyl group (e.g., cyclopropyl, cyclohexyl, bicyclo[2,2,1]heptyl, adamantly), alkenyl group (e.g., 2-propylene, oleyl), aryl group (e.g., phenyl o-tolyl, o-anisyl, 1-naphthyl, 9-anthranyl), heterocyclic group (e.g., 2-tetrahydrofuryl, 2-thiophenyl, 4-imidazolyl, 2-pyridyl), halogen atom (e.g., fluorine atom, chlorine atom, bromine atom, iodine atom), cyano group, nitro group, hydroxyl group, carbonyl group (e.g., alkylcarbonyl such as acetyl, trifluoroacetyl and pivaloyl; arylcarbonyl group such as benzoyl, pentafluorobenzoyl, 3,5-di-t-butyl-4-hydroxybenzoyl), oxycarbonyl group (e.g., alkoxycarbonyl such as methoxycarbonyl, cyclohexyloxycarbonyl and n-dodecyloxycarbonyl; aryloxycarbonyl such as phenoxycarbonyl, 2,4-di-t-amylphenoxycarbonyl and 1-naphthyloxycarbonyl; heterocyclic-oxycarbonyl such as 2-pyridyloxycarbonyl, 1-phenylpyrazolyl5-oxycarbonyl), carbamoyl group (e.g., alkylcarbamoyl such as dimethylcarbamoyl, 4-(2,4-di-t-amylphenoxy)butylaminocarbonyl; arylcarbamoyl such as phenylcarbamoyl and 1-naphthylcarbamoyl), alkoxy group (e.g., methoxy, 2-ethoxyethoxy), aryloxy group (e.g., phenoxy, 2,4-di-t-amylphenoxy, 4-(4-hydroxyphenylsulfonyl)phenoxy), heterocyclic-oxy group (e.g., 4-pyridyloxy, 2-hexahydropyranyloxy), carbonyloxy group (e.g., alkylcarbonyloxy such as acetyloxy, trifluoroacetyloxy, pivaloyloxy; arylcarbonyloxy such as benzoyloxy and pentafluorobenzoyloxy), urethane group (e.g., alkylurethane group such as N,N-dimethylurethane; arylurethane group such as N-phenylurethane and N-(p-cyanophenyl)urethane), sulfonyloxy group (e.g., alkylsulfonyloxy such as methanesulofonyloxy, trifluoromethanesulfonyloxy and n-dodecanesulfonyloxy; arylsulfonyloxy such as benzenesulfonyloxy and p-toluenesulfonyloxy), an amino group (e.g., alkylamino such as dimethylamino, cyclohexylamine and npdodecylamino; arylamino such as anilino and p-tpoctylanilino), sulfonylamino group (e.g., methanesulfonylamino, heptafluoropropanesulfonylamino and n-hexadecylsulfonylamino; arylsulfonylamino such as p-toluenesulfonylamino and pentafluorobenzenesulfonylamino), sulfamoylamino group (e.g., alkylsufamoylamino such as N,N-dimethylsulfamoylamino; arylsulfamoylamino such as N-phenylsulfamoylamino), acylamino group (e.g., alkylcarbonylamino such as acetylamino and myrystoylamino; arylcarbonylamino such as benzoylamino), ureido group (e.g., alkylureido such as N,N-dimethylureido; arylureido such as N-phenylureido and N-(p-cyanophenyl)ureido), sulfonyl group (e.g., alkylsulfonyl such as methanesulfonyl and trifluoromethasulfonyl; arylsulfonyl such as p-toluenesulfonyl), sulfamoyl group (e.g., alkysulfamoyl such as dimethylsulfamoyl, 4-(2,4-di-t-amylphenoxy)butylaminosulfonyl; arylsulfamoyl such as phenylsulfamoyl), alkylthio group (e.g., methylthio, t-octylthio), arylthio group (e.g., phenylthio), and heterocyclic-thio group (e.g., 1-phenyltetrazole-5-thio, 5-methyl-1,3,4-oxadiazole-2-thio).

Cycloalkyl and alkenyl groups may be substituted. Examples of a substituent are the same as defined in the foregoing. An alkynyl group include, for example, 1-propyne, 1-butyne and 1-hexyne.

As R₁₁ and R₁₂ are also preferred a group forming a non-aromatic cycle structure (e.g., pyrrolidine ring, piperazine ring, morpholine ring).

R₁₃ is a substituent as described above and preferably an alkyl group, cycloalkyl group, alkoxy group, or acylamino group, and n is an integer of 0 to 4, provided that when n is 2 or more, plural R₁₃s may be the same or different.

R₁₄ is an alkyl group such as methyl, ethyl, iso-propyl, t-butyl, n-dodecyl and 1-hexylnonyl. R₁₄ is preferably a secondary or tertiary alkyl group such as i-propyl, sec-butyl, t-butyl or 3-heptyl, and more preferably iso-propyl or t-butyl. The alkyl group of R₁₄ may be substituted by a substituent, provided that the substituent is comprised of carbon and hydrogen atoms and does not contain other atoms.

R₁₅ is an alkyl group such as n-propyl, i-propyl, t-butyl, n-dodecyl, or 1-hexylnonyl. R₁₅ is preferably secondary or tertiary alkyl group, such as i-propyl, sec-butyl, t-butyl or 3-heptyl; and more preferably I-propyl or t-butyl. The alkyl group of R₁₅ may be substituted by a substituent, provided that the substituent is comprised of carbon and hydrogen atoms and does not contain other atoms.

R₁₆ is an alkyl group such as n-propyl, n-butyl, n-pentyl, n-hexyl, n-heptyl, I-propyl, sec-butyl, t-butyl or 3-heptyl. R₁₆ is preferably a straight alkyl group having 3 or more carbon atoms, such as n-propyl, n-butyl, n-pentyl, n-hexyl or n-hexyl, and more preferably n-propyl or n-butyl. The alkyl group of R₁₆ may be substituted by a substituent, provided that the substituent is comprised of carbon and hydrogen atoms and does not contain other atoms.

Chelating yellow dyes include, for example, a compound represented by the following formula (2): 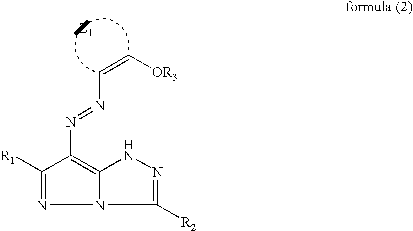
wherein R₁ and R₂ are each a substituent; R₃ is an alkyl group or aryl group; Z₁ is an atomic group necessary to form a 5- or 6-membered ring.

In the formula (2), Examples of a substituent represented by R₁ and R₂ include a halogen atom, an alkyl group (alkyl group having 1 to 12 carbon atoms, which may be substituted by a group interrupted with an oxygen atom, nitrogen atom, sulfur atom or carbonyl group, or substituted by an aryl group, alkenyl group, alkynyl group, hydroxy group, amino group, nitro group, carboxyl group, cyano group or a halogen atom; e.g., methyl, I-propyl, t-butyl, trifluoromethyl, methoxymethyl, 2-methanesulfonylethyl, 2-methanesulfoneamidoethyl, cyclohexyl), aryl group (e.g., phenyl, 4-t-butylphenyl, 3-nitrophenyl, 3-acylaminophenyl, 2-methoxyphenyl), cyano group, alkoxy group, aryloxy group, acylamino group, anilino group, ureido group, sulfamoyl group, alkylthio group, arylthio group, alkoxycarbonylamino group, sulfonamido group, carbamoyl group, sulfamoyl group, sulfonyl group, alkoxycarbonyl group, heterocyclic-oxy group, acyloxy group, carbamoyloxy group, silyloxy group, aryloxycarbonylamino group, imido group, heterocyclic-thio group, phosphonyl group and acyl group.

The alkyl and aryl group represented by R₃ are the same as those of R₁ and R₂. Examples of a 5- or 6-membered ring formed by Z₁ together with two carbon atoms include benzene, pyridine, pyrimidine, triazine, pyrazine, pyridazine, pyrrole, furan, thiophene, pyrazole, imidazole, triazole, oxazole, and thiazole. These rings may further condense with other aromatic rings to form a condensed ring. The foregoing rings may be substituted by a substituent and examples of such a substituent are the same as those described in R₁ and R₂.

Chelating magenta dyes include, for example, a compound represented by the following formula (3): 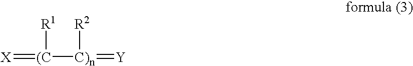
wherein X is a group or atom capable of forming a at least two dentate chelate; Y is an atomic group necessary to form a 5- or 6-membered aromatic hydrocarbon ring or heterocyclic ring; R₁ and R₂ are each a hydrogen atom, a halogen atom or a univalent substituent; n is 0, 1 or 2.

X is preferably represented by the following formula (4): 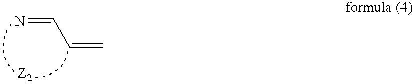
wherein Z₂ is an atomic group necessary to form an aromatic nitrogen-containing heterocyclic ring which is substituted by a chelatable, nitrogen-containing group. Examples of the ring include pyridine, pyrimidine, thiazole, and imidazole. The ring may further form a condensed ring together with other carbocyclic rings (e.g., benzene ring) and heterocyclic rings (e.g., pyridine ring).

In the foregoing formula (3), Y is an atomic group necessary to form a 5- or 6-membered aromatic hydrocarbon ring or heterocyclic ring, which may further be substituted or condensed. Specific examples of the ring include a 3H-pyrrole ring, oxazole ring, imidazole ring, thiazole ring, 3H-pyrrolidine ring, oxazolidine ring, imidazolidine ring, thiazolidine ring, 3H-indole ring, benzoxazole ring, benzimidazole ring, benzothiazole ring, quinoline ring and pyridine ring. The ring may further condense with other carbocyclic rings (e.g., benzene ring) or a heterocyclic ring (e.g., pyridine ring) to form a condensed ring. Substituents capable of being substituted onto the ring include, for example, an alkyl group, aryl group, heterocycle group, acyl group, amino group, nitro group, cyano group, acylamino group, alkoxy group, hydroxyl group, alkoxycarbonyl group and halogen atom. The foregoing groups may further be substituted.

R₁ and R₂ are each a hydrogen atom, a halogen atom (e.g., fluorine atom, chlorine atom) or a univalent substituent (e.g., alkyl group, alkoxy group, cyano group, alkoxycarbonyl group, aryl group, heterocycle group, carbamoyl group, hydroxy group, acyl group, acylamino group).

X is a group or atom capable of forming a at least two dendate chelate and include any one capable of forming a dye of formula (3), preferred examples thereof include 5-pyrazolone, imidazole, pyrazolopyrrole, pyrazolopyrazole, pyrazoloimidazole, pyrazolotetrazole, barbituric acid, thiobarbituric acid, rhodanine, hydantoin, thiohydantoin, oxazoline, isooxazolone, indanedione, pyrazolidinedione, oxazolidinedione, hydroxypyridone, and pyrazolopyridone.

Binder Resin

The dye layer relating to this invention contains a binder resin together with the foregoing dye. Any of binder resins used in conventional sublimation type thermal transfer sheet can be employed as a binder resin used for the dye layer. Examples of a binder resin include water-soluble polymers of a cellulose type, polyacrylic acid type, polyvinyl alcohol type and polyvinyl pyrrolidone type; and polymers soluble in an organic solvent, such as acryl resin, methacryl resin, polystyrene, polycarbonate, polysulfone, polyethersulfone, polyvinyl butyral, polyvinyl acetal, ethyl cellulose and nitrocellulose. Of these, polyvinyl butyral, polyvinyl acetal and cellulose type resin, which exhibit superior storage stability, are preferred.

The content of a dye or binder resin of the dye layer is not specifically limited and optimally set in terms of performance.

In addition to the foregoing dye and binder, the dye layer may contain various commonly known additives. The dye layer can be formed, for example, in such a manner that an ink coating solution, prepared by dissolving or dispersing a dye, binder resin and other additives is coated on a substrate sheet by known means such as a gravure coating method, followed by drying. The thickness of the dye layer is usually 0.1 to 3.0 μm, and preferably 0.3 to 1.5 μm.

Protective Layer

The thermal transfer sheet relating to this invention is preferably provided with a thermally transferable protective layer. The thermally transferable protective layer is comprised of a transparent resin layer which is transferred onto the image receiving layer to cover the surface of the formed image. Examples of resin to form a protective layer include polyester resin, polystyrene resin, acryl resin, polyurethane resin, acrylurethane resin, polycarbonate resin, and epoxy- or silicone-modified resins of the foregoing, a mixture of the resins described above, ionizing radiation-curing resin and ultraviolet shielding resin. Of these, polyester resin, polycarbonate resin, epoxy-modified resin and ionizing radiation-curing resin are preferred. As polyester resin is preferred alicyclic polyester resin in which diol and acid constituents are each composed of at least one alicyclic compound. Polycarbonate resin is preferably an aromatic polycarbonate resin and an aromatic polycarbonate resin described in JP-A No. 11-151867 is specifically preferred.

Examples of epoxy-modified resin include epoxy-modified polyethylene, epoxy-modified polyethylene terephthalate, epoxy-modified polyphenylsufite, epoxy-modified cellulose, epoxy-modified polypropylene, epoxy-modified polyvinyl chloride, epoxy-modified polycarbonate, epoxy-modified acryl, epoxy-modified polystyrene, epoxy-modified polycarbonate, epoxy-modified polymethylmethacrylate, epoxy-modified silicone, a copolymer of epoxy-modified polystyrene and epoxy-modified polymethylmethacrylate, a copolymer of epoxy-modified acryl and epoxy-modified polystyrene, and a copolymer of epoxy-modified acryl and epoxy-modified silicone. Of these, epoxy-modified acryl, epoxy-modified polystyrene, epoxy-modified polymethylmethacylate and epoxy-modified silicone are preferred, and a copolymer of epoxy-modified polystyrene and epoxy-modified polymethylmethacrylate, a copolymer of epoxy-modified acryl and epoxy-modified polystyrene, and a copolymer of epoxy-modified acryl and epoxy-modified silicone are more preferred.

Ionizing Radiation Curing Resin

Ionizing radiation curing resin is usable as a thermally transferable protective layer. Superior resistance to plasticizer or abrasion can be achieved by allowing a thermally transferable protective layer to contain such a resin. Commonly known ionizing radiation curing resins are usable. For example, a radical polymerizable polymer or oligomer is exposed to ionizing radiation to cause cross-linking or curing, or a photopolymerization initiator is optionally added and polymerization cross-linking is caused by an electron beam or ultraviolet rays.

Ultraviolet Ray Shielding Resin

The main object of a protective layer containing an ultraviolet ray shielding resin is to provide light resistance to printed material. For example, a resin obtained by allowing a reactive ultraviolet absorbent to react with or bind to a thermoplastic resin or the foregoing ionizing radiation curing resin is usable as a ultraviolet ray shielding resin. Specifically, there is exemplified introduction of a reactive group such as an addition-polymerizing double bond (e.g., vinyl group, acryloyl group, methacryloyl group), an alcoholic hydroxyl group, an amino group, a carboxyl group, epoxy group, and isocyanate group into non-reactive organic ultraviolet absorbents such as salicylate type, benzophenone type, benzotriazole type, substituted acrylonitrile, nickel chelate type, and hindered amine type.

The main protective layer provided in the foregoing thermally transferable protective layer of a single layer structure or multilayer structure usually forms a thickness of 0.5 to 10 μm, depending on the kind of resin used for the protective layer.

The thermally transferable protective layer is preferably provided via a non-transferable mold-releasing layer on a substrate sheet.

A non-transferable mold-releasing layer (which is hereinafter also denoted simply as a releasing layer) preferably contains (1) inorganic microparticles having an average particle size of not more than 40 nm in an amount of 30% to 80% by weight together with a resin binder, (2) a copolymer of alkyl vinyl ether and anhydrous maleic acid, its derivative or its mixture in an amount of not less than 20%, or (3) an ionomer in an amount of not less than 20% by weight to maintain adhesion between a substrate sheet and a non-transferable releasing layer stronger than adhesion between the non-transferable releasing layer and a thermally transferable protective layer and to achieve adhesion between the non-transferable releasing layer and the thermally transferable protective layer after heat-applied stronger than that before heat-applied. A non-transferable releasing layer may optionally contain additives.

Examples of inorganic microparticles usable in this invention include particulate silica such as anhydrous silica or colloidal silica, and metal oxides such as tin oxide, zinc oxide and zinc antimonate. Inorganic microparticles preferably have a particle size of not more than 40 nm. A particle size of more than 40 nm increases unevenness of the surface of a thermally transferable protective layer due to unevenness of the surface of a releasing layer, resulting in an unsuitable lowering of transparency of the protective layer.

Resin binder to be mixed with inorganic microparticles is not specifically limited and any miscible resin is usable. Examples thereof include polyvinyl alcohol (PVA) resins with various saponification degrees, polyvinyl acetal resin, polyvinyl butyral resin, acryl type resin, polyamide resin, cellulose type resin such as cellulose acetate, alkyl cellulose, carboxymethyl cellulose or hydroxyalkyl cellulose, and polyvinyl pyrrolidone resin.

The compounding ratio of inorganic microparticles to other compounding components mainly comprised of resin binder (inorganic microparticles/other compounding components) is preferably not less than 30/70 and not more than 80/20 by weight. A compounding ratio of less than 30/70 results in insufficient effects of inorganic microparticles and a compounding ratio of more than 80/20 causes incomplete film formation of the releasing layer, forming a portion in which the substrate sheet is directly in contact with the protective layer.

As a copolymer of alkyl vinyl ether and anhydrous maleic acid or its derivative, for example, one in which an alkyl group of an alkyl vinyl ether portion is methyl or ethyl and one in which an anhydrous maleic acid portion partially or completely forms a half-ester with an alcohol (e.g., methanol, ethanol, propanol, isopropanol, butanol, isobutanol) are usable.

The releasing layer may be formed of a copolymer of alkyl vinyl ether and anhydrous maleic acid, its derivative or its mixture but other resins or microparticles may further be added thereto to adjust peeling force between the releasing layer and the protective layer. In that case, the releasing layer desirably contains a copolymer of alkyl vinyl ether and anhydrous maleic acid, its derivative or its mixture in an amount of not less than 20% by weight. A content of less than 20% by weight makes it difficult to achieve sufficient effect of a copolymer of alkyl vinyl ether and anhydrous maleic acid, its derivative or its mixture. There is usable, as a resin or microparticles to be compounded with a copolymer of alkyl vinyl ether and anhydrous maleic acid or its derivative, any material which is capable of forming highly transparent film. For example, the foregoing inorganic microparticles and a resin binder which is miscible with the inorganic microparticles are preferably used.

Examples of an ionomer usable in this invention include Serlin A (Du Pont Co.) and Chemiperal S series (Mitsui Sekiyukagaku Co., Ltd.). Further as an ionomer, for example, inorganic microparticles described above, resin binder miscible with inorganic microparticles, or other resin or microparticles may be appropriately added.

The non-transferable releasing layer is formed in such a manner that a coating solution containing either one of the foregoing compositions (1) to (3) in a prescribed compounding ratio is prepared and the thus prepared coating solution is coated on a substrate sheet by commonly known methods such as a gravure coating method or gravure reverse coating method and the coated layer is dried. The dry thickness of a non-transferable releasing layer is preferably from 0.1 to 2.0 μm.

A thermally transferable protective layer which is provided on a substrate sheet with or without intervening with the foregoing non-transferable releasing layer, may be a single layer structure or a multilayer structure. In the case of a multilayer structure, in addition to the main protective layer mainly contributing to provide various kinds of durability to images, for example, an adhesion layer may be arranged on the outermost surface of the thermally transferable protective layer to enhance adhesion between the thermally transferable protective layer and the image receiving surface of printed material, or there may be provided a preliminary protective layer or a layer to provide a function other than functions inherent to the protective layer (e.g., forgery prevention, a hologram layer). The arrangement order of the main protective layer and other layers is optional, but other layers are usually arranged between the adhesion layer and the main protective layer so that the main protective layer is the outermost surface of the image receiving side after being transferred.

There may be formed an adhesion layer on the outermost surface of the thermally transferable protective layer. An adhesion layer can be formed of resin exhibiting superior adhesion property upon heating, such as acryl resin, vinyl chloride resin, vinyl acetate resin, vinyl chloride/vinyl acetate copolymer resin, polyester resin or polyamide resin. In addition to the foregoing resins, there may be optionally added an ionizing radiation curing resin or ultraviolet shielding resin. The thickness of an adhesion layer is usually from 0.1 to 5.0 μm.

To form a thermally transferable protective layer on the non-transferable releasing layer or substrate sheet, for example, a protective layer coating solution containing resin to form a protective layer, an adhesion layer coating solution containing a heat-adhesive resin and a coating solution to form an optional layer which were previously prepared, are coated on the nontransferable releasing layer or substrate sheet in the predetermined order and then dried. The respective coating solutions are coated in commonly known methods. There may be provided a primer later between the respective layers.

Ultraviolet Absorbent

At least one of the thermally transferable protective layers preferably contains an ultraviolet absorbent. When contained in a transparent resin layer, the transparent resin layer is present on the outermost surface of printed material after the protective layer is transferred and subjects to influences from its surroundings over a long period of time, resulting in lowering in its effects, so that it is preferred to be contained in a heat-sensitive adhesive layer.

Ultraviolet absorbents include a salicylic acid type, benzophenone type, benzotriazole type and cyanoacrylate type, which are commercially available under such trade names as Tinuvin P, Tinuvin 234, Tinuvin 326, Tinuvin 327, Tinuvin 328, Tinuvin 312 and Tinuvin 315 (Ciba Geigy); Sumisorb-110, Sumisorb-130, Sumisorb-140, Sumisorb-200, Sumisorb-250, Sumisorb-300, Sumisorb-320, Sumisorb-340, Sumisorb-350 and Sumisorb-400 (Sumitomo Kagakukogyo Co., Ltd.); Mark LA-32, Mark LA-36, and Mark 1413 (Adeka Argas Kagaku Co., Ltd.) and these are usable in this invention.

There is also usable a random copolymer exhibiting a Tg of at least 60° C. (preferably, at least 80° C.) which can be obtained by allowing a reactive ultraviolet absorbent and an acryl monomer to randomly copolymerized. As the foregoing reactive ultraviolet absorbents are usable those which are obtained by introducing an addition-polymerizable double bond such as a vinyl group, acryloyl group or methacryloyl group, alcoholic hydroxyl group, amino group, carboxyl group, epoxy group or isocyanate group into non-reactive ultraviolet absorbents of commonly known salicylate type, benzophenone type, benzotriazole type, substituted acrylonitrile type, nickel chelate type and hindered amine type, and which are commercially available in such trade name as UVA635L and UVA633L (manufactured by BASF Japan Co., Ltd.); and PUVA-30M (manufactured by Otsuka Kagaku Co., Ltd.), any of which are usable in this invention.

In the random copolymer of a reactive ultraviolet absorbent and acrylic monomer, the content of a reactive ultraviolet absorbent is usually from 10% to 90% by weight, and preferably from 30% to 70%. Such a random copolymer has a molecular weight of 5,000 to 250,000, and preferably 9,000 to 30,000. The foregoing ultraviolet absorbent and random copolymer of a reactive ultraviolet absorbent and acrylic monomer may be contained singly or in combination. A random copolymer of a reactive ultraviolet absorbent and acrylic monomer is contained preferably in an amount of 5 to 50% by weight, based on the layer to be contained.

In addition to an ultraviolet absorbent, there may be incorporated other light stabilizing agents. The light stabilizing agent is a chemical capable of preventing a dye from deterioration or decomposition by absorbing or shielding an action of deteriorating or decomposing a dye, such as light energy, heat energy or an oxidizing action. Specific examples thereof include light stabilizers conventionally known as additives to synthetic resin as well as the foregoing ultraviolet absorbent. It may be incorporated to at least one of the thermally transferable layers, i.e., at least one of the foregoing peeling layer, transparent resin layer and heat-sensitive adhesion layer.

The foregoing light stabilizing agents including an ultraviolet absorber are contained preferably in an amount of from 0.05 to 10 parts by weight, and more preferably from 3 to 10 parts by weight, based on 100 parts of the resin forming the layer. An excessively small amount is difficult to achieve desired effects as a light stabilizing agent and an excessively large amount is not economical.

In addition to the light stabilizing agent, various additives such as a brightener or filler may be incorporated in an appropriate amount to the adhesion layer.

The transparent resin layer of a protective layer transfer sheet may be provided on a substrate sheet alone or face-sequentially to a dye layer of the transfer sheet.

Heat-Resistant Slippage Layer

The thermal transfer sheet is preferably provided with a heat-resistant slippage layer on the opposite side of a substrate sheet from a dye layer. The heat-resistant slippage layer prevents thermal fusion of the substrate sheet with a heating device such a thermal head and achieves smooth traveling performance, and also removes deposits onto a thermal head.

Natural or synthetic resins are employed alone or in combination, as a resin used for the heat-resistant slippage layer and examples thereof include cellulose type resin such as ethyl cellulose, hydroxyethyl cellulose, hydroxypropyl cellulose, methyl cellulose, cellulose acetate, cellulose acetate butyrate and nitrocellulose; vinyl type resin such as polyvinyl alcohol, polyvinyl acetate, polyvinyl butyral, polyvinyl acetal and polyvinyl pyrrolidone; acryl type resin such as poly(methyl methacrylate), poly(ethyl acrylate), polyacrylamide and acrylonitrile-styrene copolymer; polyimide resin, polyamide resin, polyamidoimide resin, polyvinyltoluene resin, chromaneindene resin, polyester type resin, polyurethane resin, silicon- or fluorine-modified urethane resin. It is preferred that, to enhance heat resistance of the heat-resistant slippage layer, a resin containing a reactive hydroxyl group, of the foregoing resins, is used in combination with a curing agent such as polyisocyanate to form a cured resin layer.

To provide lubricating capability on a thermal head, a solid or liquid mold-releasing agent or lubricant may be added to the heat-resistant slippage layer to enhance heat-resistance. Examples of a mold-releasing agent or lubricant include waxes such polyethylene wax or paraffin wax, higher aliphatic alcohol, organosiloxane, anionic surfactants, cationic surfactants, amphoteric surfactants, nonionic surfactants, fluorinated surfactants, metal soap, organic carboxylic acids and their derivatives, fluororesin, silicone resin, and inorganic particles such as talc or silica. A lubricant is contained in the heat-resistant slippage layer in an amount of 5% to 50% by weight, and preferably 10% to 30%. The thickness of a heat-resistant slippage layer is usually from 0.1 to 10.0 μm, and preferably 0.3 to 5.0 μm.

### Thermal Transfer Image Receiving Sheet

Next, there will be described a thermal transfer image receiving sheet which is constituted of a substrate sheet and a dye receiving layer.

Substrate Sheet

A substrate sheet used in a thermal transfer image receiving sheet plays the role of supporting a dye receiving layer and heat is applied thereto at the time of thermal transfer, and it is therefore preferred to have mechanical strength at levels of causing no problem in handling, even when excessively heated.

Material for such a substrate is not specifically limited and examples thereof include condenser paper, glassine paper, sulfuric acid paper or high-sizing paper, synthetic paper (polyolefin type, polystyrene type), fine-quality paper, art paper, coat paper, cast coat paper, wallpaper, backing paper, synthetic resin- or emulsion-impregnated paper, synthetic rubber latex-impregnated paper, synthetic resin-incorporated paper, fiber board, cellulose fiber paper; films of polyester, polyacrylate, polycarbonate, polyurethane, polyimide, polyetherimide, cellulose derivatives, polyethylene, ethylene vinyl acetate copolymer, polypropylene, polystyrene, acryl, polyvinyl chloride, poluethylidene chloride, polyvinyl alcohol, polyvinyl butyral, nylon, polyether ether ketone, polysulfone, polyether sulfone, tetrafluoroethylene-ethylene, tetrafluoroethylene, hexafluoropropylene, polychlorotrifluoroethylene and polyvinylidene fluoride; white opaque film obtained by adding a white pigment or a filler to the foregoing synthetic resins or blowing sheet.

There can also be employed laminated material using a combination of the foregoing substrates. A representative laminated material is, for example, laminate paper of cellulose fiber paper and synthetic paper and laminated paper of cellulose synthetic paper and plastic film. The foregoing substrate sheets may be at any reasonable thickness and preferably at 10 to 300 μm.

It is preferred to allow a layer containing fine voids, which results in high quality images without density unevenness or white spots, as well as further enhanced printing sensitivity. Plastic film or synthetic paper containing internal fine voids is usable as a layer containing fine voids (hereinafter, also denoted as fine-void containing layer). A plastic film or synthetic paper which is obtained by blending polyolefin, specifically containing polypropylene as a main component with inorganic pigments and/or a polymer inmiscible with polypropylene as a void formation component, followed by film formation and stretching, is preferred as plastic film or synthetic paper containing fine voids. Plastic film or paper mainly composed of polyester is inferior in cushioning property and heat-insulating ability due to its viscoelastic and thermal properties, compared to one mainly composed of polypropylene, resulting in lowered printing sensitivity and density unevenness.

In view of the foregoing, a plastic film or synthetic paper preferably exhibits an elastic modulus of 5×10⁸ to 1×10¹⁰ Pa at 20° C. Film formation of the plastic film or synthetic paper is conducted with being biaxially stretched so that it readily shrinks on heating. When allowed to stand for 60 sec at 110° C., it exhibits a shrinkage factor of 0.5% to 2.5%. The plastic film or synthetic paper may be a single fine-void containing layer or composed of plural layers. In the case of being composed of plural layers, all of the layers may contain fine voids or there may be included a layer containing no void. There may be incorporated a white pigment as a shielding agent to the plastic film or synthetic paper. There may also be incorporated additives such as a brightener to enhance whiteness. The fine-void containing layer preferably has a thickness of 30 to 80 μm.

The fine-void containing layer can be formed by coating a layer containing fine voids on a substrate. Commonly known plastic resins such as polyester, urethane resin, polycarbonate, acryl resin, polyvinyl chloride, and polyvinyl acetate are usable alone or in a blend of them.

For the purpose of anti-curling, there may optionally be provided a layer of resins such as polyvinyl alcohol, polyvinylidene chloride, polyethylene, polypropylene, modified polyolefin, polyethylene terephthalate or polycarbonate, or a layer of synthetic paper on the side of the substrate opposite a dye receiving layer. Commonly known lamination methods are applicable, including, for example, dry lamination, non-solvent (hot melt) lamination, and EC lamination methods. Of these, dry lamination and non-solvent lamination methods are preferred. Adhesives suitable for the non-solvent lamination method include, for example, Takenate 720L, manufactured by Takeda Yakuhin Kogyo Co., Ltd. and adhesives suitable for the dry lamination method include, for example, Takelac A969/Takenate A-5(3/1), manufactured by Takeda Yakuhin Kogyo Co., Ltd., and polysol PSA SE-1400, Vinylol PSA AV-6200 series, manufactured by Showa Kobunshi Co., Ltd. Adhesives are used at a solid content of 1 to 8 g/m², preferably 2 to 6 g/m².

As described above, a plastic film and a plastic paper, each of them, or various paper and plastic film or paper can be laminated via an adhesion layer.

It is preferred to apply various primer treatments or a corona discharge treatment to the substrate surface to enhance adhesion strength between the substrate sheet and the dye receiving layer.

Binder Resin

Commonly known binder resins can be used in the thermal transfer image receiving sheet and ones which easily dye are preferably used. Specific examples thereof include a polyolefin resin such as polypropylene, halogenated resin such as polyvinyl chloride or polyvinylidene chloride, vinyl type resin such as polyvinyl acetate or poly(acrylic acid ester), polyester resin such as polyethylene terephthalate or polybutylene terephthalate, polystyrene resin, polyamide resin, phenoxy resin, copolymer of olefins such as ethylene or propylene and other vinyl type resins, polyurethane, polycarbonate, acryl resin ionomer, cellulose derivatives, and a mixture of the foregoing resins. Of these, polyester type resin, polyvinyl type resin and cellulose derivatives are preferred.

Mold-Releasing Agent

To prevent thermal fusing onto the dye layer, the dye receiving layer preferably incorporates a mold-releasing agent (hereinafter, also denoted simply as releasing agent). Mold-releasing agents usable in this invention include, for example, a phosphoric acid ester type plasticizer, fluorinated compounds and silicone oil (including reactive curing silicone), and of these, silicone oil is preferred. Dimethylsilicone and various modified silicones are usable as a silicone oil. Specific examples thereof include amino-modified silicone, urethane-modified silicone, alcohol-modified silicone, vinyl-modified silicone, urethane-modified silicone, which may be blended or polymerized by employing various reactions. Mold-releasing agents may be used alone or in a combination of them. A mold-releasing agent is added preferably in an amount of 0.5 to 30 parts by weight, based on 100 parts of binder resin used in the dye receiving layer. Addition falling outside the foregoing range often causes problems such as fusing of the thermal transfer sheet to the dye receiving layer of a thermal transfer image receiving sheet or lowering in printing sensitivity. Instead of incorporating a mold-releasing agent to a dye receiving layer, there may be separately provided a mold-releasing layer onto the dye receiving layer.

Interlayer

The thermal transfer sheet may be provided with an interlayer between the substrate sheet and a dye receiving layer. The interlayer refers to all layers existing between the substrate sheet and the dye receiving layer, which may also be multilayered. Functions of the interlayer include solvent resistance capability, barrier performance, adhesion performance, whitening capability, masking capability and antistatic capability. Any interlayer known in the art is applicable without being specifically limited.

In order to provide solvent resistance capability and a barrier performance to the interlayer, a water-soluble resin is preferably used. Specific examples of water-soluble resin include cellulose type resins such as carboxymethyl cellulose, polysaccharide type resins such as starch, proteins such as casein, gelatin, agar, vinyl type resins such as polyvinyl alcohol, ethylene vinyl acetate copolymer, polyvinyl acetate, polyvinyl chloride, vinyl acetate copolymer (e.g., BEOPA, manufactured by Japan Epoxy Resin Co., Ltd.), vinyl acetate (metha)acryl copolymer, (metha)acryl resin, styrene (metha)acryl copolymer and styrene resin; melamine resin, urea resin, polyamide type resin such as benzoguanamine resin, polyester and polyurethane. The water-soluble resin is one which is completely dissolved in an aqueous solvent mainly comprised of water (having a particle size of not more than 0.01 μm) or dispersed in the form of colloidal dispersion (having a particle size of 0.01 to 0.1 μM), emulsion (having a particle size of 0.1 to 1.0 μm) or a slurry (having a particle size of more than 1.0 μm). Of the foregoing resins, those which are not dissolved or not swelled in general-purpose solvents such as alcohols (e.g., methanol, ethanol, isopropyl alcohol), hexane, cyclohexane, acetone, methyl ethyl ketone, xylene, ethyl acetate, butyl acetate and toluene. In this sense, a resin which is completely dissolved in a solvent, mainly composed of water, is more preferred. Polyvinyl alcohol resin and cellulose resin are cited.

In order to provide adhesion capability to the interlayer, urethane resin or a polyolefin type resin is general used, depending on the kind of substrate sheet or the surface treatment thereof. The combined use of a thermoplastic resin containing an active hydrogen and a curing agent such as an isocyanate compound achieves superior adhesion properties. There are employed fluorescent brightening agents to provide whitening capability to the interlayer. Any compound known as a fluorescent brightening agent is usable and examples thereof include stilbene type, distilbene type, benzoxazole type, styryl-oxazole type, pyrane-oxazole type, coumalin type, aminocoumalin type, imidazole type, benzimidazole type, pyrazoline type and distyryl-biphenyl type brightening agents. Whiteness can be controlled by the kind and the content of the fluorescent brightening agent. Fluorescent brightening agents can be added by any means. Examples thereof include addition through solution in water, addition through pulverizing dispersion by using a ball mill or a colloid mill, a method of dissolving in a high boiling solvent, dispersing in a hydrophilic colloid solution and adding it in the form of oil-in-water type dispersion, and addition by impregnating with a polymer latex.

To conceal surface glare or unevenness of the substrate sheet, titanium oxide may be added to the interlayer. The use of titanium oxide, which expands freedom of choice of substrate sheets, is preferred. Titanium oxide includes two types, rutile type titanium oxide and anatase type titanium oxide. Taking into account whiteness and effects of a fluorescent brightener, the anatase type titanium oxide which exhibits ultraviolet absorption at shorter wavelengths than the rutile type one is preferred. In cases when a binder of the interlayer is an aqueous type and titanium oxide is difficult to be dispersed therein, titanium oxide which has been subjected to a hydrophilic surface treatment, may be used or commonly known dispersing agents such as surfactants or ethylene glycol may be used to perform dispersion. The content of titanium oxide is preferably from 10 to 400 parts by weight, based on 100 parts by weight of resin solids.

To provide the interlayer with an antistatic capability, electrically conductive material known in the art, such as a conductive inorganic filler or an organic conductive material, e.g., poly(anilinesulfonic acid) is optimally chosen so as to be compatible with the interlayer binder resin. It is preferred to have the interlayer thickness fall within the range of 0.1 to 10 μm.

Next, there will be described recording methods by using the thermal transfer recording material of this invention.

First, embodiments in which a thermally transferable protective layer or the post-heat treatment region is supplied successively with the respective dye layers of thermal transfer sheets will be described based of drawings. FIG. 2 is a sectional view showing one embodiment of supplying the thermal transfer sheet of this invention in one face-sequence. In FIG. 2, thermal transfer sheet (21) is provided with dye layers 23Y, 23M and 23C corresponding to the respective dyes of yellow (Y), magenta (M) and cyan (C), and a thermal transfer protective layer or post-heat treatment region (23OP) which is located in a separate region from the dye layer, and these are successively provided in this sequence on the same surface of the substrate sheet.

In FIG. 2, a slight spacing is provided between the respective dye layers but a spacing may optimally be provided in accordance with the control method of a thermal transfer recording apparatus. To precisely access the respective dye layers, it is preferred to provide a detection mark onto a thermal transfer sheet and the method thereof is not specifically limited. In the foregoing, the respective dye layers, and a thermally transferable protective layer or a post-heat treatment region are shown to be provided on the same plane surface but it is obvious that the respective layers may be provided on separate sheets. In cases when reactive dyes are used in the respective dye layers, the dyes contained in them are unreacted compounds, and, strictly speaking, they are not Y, M and C dyes, but the respective dye layers are similarly represented, for convenience, in a sense of layers to finally form Y, M and C images.

In the invention, specifically in sublimation type thermal transfer of a chelate type, it is preferred to conduct a post-heat treatment after dye transfer to complete chelation of the transferred dye. In the post-heat treatment, heating by a thermal head is conducted so as to achieve uniform heat distribution, whereby glossy images are suitably formed along with completion of the reaction. Alternatively, the post-heat treatment and transfer of the transferable protective layer may be performed simultaneously, in which heating by a thermal head to achieve uniform heat distribution can form glossy images.

### EXAMPLES

The present invention will be further described based on examples but embodiments of the invention are by no means limited to these.

### Thermal Transfer Image Receiving Sheet

Preparation of Image Receiving Sheet 1

On one side of a 150 μm thick synthetic plastic paper sheet as a substrate sheet (YUPO FPG-150, manufactured by Oji Yuka Goseishi Co., Ltd.), the following interlayer coating solution was coated by a wire bar coating system and dried at 120° C. for 1 min. to form a sublayer having a dry solid content of 2.0 g/m². Subsequently, on the sublayer, a dye receiving layer coating solution (1) having the following composition was coated by a wire bar coating system to exhibit a dry solid content of 4 g/m² and dried at 110° C. for 30 sec. to obtain a thermal transfer image receiving sheet 1.

Interlayer coating solution:

| | | |
|---|---|---|
| 35% Aqueous acryl type resin emulsion | 5.7 | wt. parts |
| (NIKAZOL A-08, Nippon Carbide Kogyo) | | |
| Pure water | 94.0 | wt. parts |

Dye receiving layer coating solution 1:

| | | |
|---|---|---|
| B1: copolymer of vinylchloride and vinyl | 10.0 | wt. parts |
| acetate (vinyl chloride/vinyl acetate = 95/5) | | |
| Mold-releasing agent 1: epoxy- | 1.0 | wt. parts |
| modified silicone (X-22-8300T, | | |
| Shin-Etsu Kagaku Kogyo) | | |
| Solv 1: methyl ethyl ketone/toluene = 1/1 | 40.0 | wt. parts |

Preparation of Image Receiving Sheets 2 to 18

Thermal transfer image receiving sheets 2 to 18 were prepared similarly to the foregoing thermal transfer image receiving sheet 1, provided that the composition of the foregoing dye receiving layer coating solution 1 was varied as shown in Table 1.

TABLE 1

| | | | Metal Ion | | | | | |
|---|---|---|---|---|---|---|---|---|
| Image | Binder | Releasing | Containing | Metal | Sodium | | pH of | |
| Receiving | (wt. | Agent | Compound | Species | Acetate | Solvent | Coating | |
| Sheet | part) | (wt. parts) | (wt. part) | (wt. part) | (wt. part) | (wt. part) | Solution | Remark |
| 1 | B1 (10) | 1 (1) | — | — | — | Solv1 (40) | — | Comp. |
| 2 | B1 (10) | 1 (1) | — | M-1 (0.25) | — | Solv1 (40) | — | Comp. |
| 3 | B1 (10) | 1 (1) | — | M-2 (2.5) | — | Solv1 (40) | — | Inv. |
| 4 | B1 (10) | 1 (1) | — | M-3 (2.5) | — | Solv1 (40) | — | Inv. |
| 5 | B1 (10) | 1 (1) | — | M-4 (2.5) | — | Solv1 (40) | — | Inv. |
| 6 | B1 (10) | 1 (1) | — | M-5 (2.5) | — | Solv1 (40) | — | Inv. |
| 7 | B1 (10) | 1 (1) | — | M-6 (2.5) | — | Solv1 (40) | — | Inv. |
| 8 | B1 (60) | 2 (0.7) | MS-1 (40.0) | — | — | Solv1 (200) | — | Comp. |
| 9 | B1 (60) | 2 (0.7) | MS-1 (40.4) | — | — | Solv1 (200) | — | Comp. |
| 10 | B1 (60) | 2 (0.7) | MS-1 (40.0) | M-2 (40.0) | — | Solv1 (200) | — | Inv. |
| 11 | B1 (60) | 2 (0.7) | MS-1 (40.0) | M-3 (40.0) | — | Solv1 (200) | — | Inv. |
| 12 | B1 (60) | 2 (0.7) | MS-1 (40.0) | M-4 (40.0) | — | Solv1 (200) | — | Inv. |
| 13 | B1 (60) | 2 (0.7) | MS-1 (40.0) | M-5 (40.0) | — | Solv1 (200) | — | Inv. |
| 14 | B1 (60) | 2 (0.7) | MS-1 (40.0) | M-7 (10.0) | — | Solv1 (200) | — | Inv. |
| 15 | B1 (60) | 2 (0.7) | MS-1 (40.0) | M-6 (40.0) | — | Solv1 (200) | — | Inv. |
| 16 | B1 (60) | 2 (0.7) | MS-1 (40.0) | M-6 (20.0) | — | Solv1 (200) | — | Inv. |
| 17 | B1 (60) | 2 (0.7) | MS-1 (40.0) | — | 1.0 | Solv1 (200) | — | Inv. |
| 18 | B1 (60) | 2 (0.7) | MS-1 (40.0) | — | — | Solv1 (200) | 4.7 | Inv. |
| 19 | B1 (60) | 2 (0.7) | MS-1 (40.0) | — | — | Solv1 (200) | 5.8 | Comp. |

Note of Table 1
B1: copolymer of vinyl chloride and vinyl acetate (vinyl chloride/vinyl acetate = 95/5)
Releasing agent 1: epoxy-modified silicone (X-22-8300T, Shi-Etsu Kagaku Kogyo)
Releasing agent 2: epoxy-modified silicone (KF-393, Shi-Etsu Kagaku Kogyo)
Metal ion containing compound
MS-1: Ni²⁺[C₇H₁₅COC(COOCH₃)═C(CH₃)O⁻]₂
Metal species
M1: nickel (II) acetylacetonato dihydride
M2: cobalt oleate (effective metal content 10 wt %)
M3: copper oleate (effective metal content 10 wt %)
M4: magnesium cebacate (effective metal content 10 wt %)
M5: aluminum isopalmitate (effective metal content 10 wt %)
M6: magnesium oleate (effective metal content 10 wt %)
M7: magnesium propionate (effective metal content 10 wt %)
Solv 1: methyl ethyl ketone/toluene = 1/1
*1: sodium acetate

### Thermal Transfer Sheet

Preparation of Substrate Sheet

Using a 6 μm thick polyethylene terephthalate film (K-203E-6F, Mitsubishi Kagaku Polyester Co., Ltd.), one side of which was subjected to an adhesion-promoting treatment, the following coating composition of a heat-resistant slippage layer was coated by a gravure coating system on the opposite side of the film to the side subjected to an adhesion-promoting treatment and dried, and further subjected to a heat-curing treatment to prepare a substrate sheet used for a thermal transfer sheet having a heat-resistant slippage layer at a dry thickness of 1 μm.

Coating composition of heat-resistant slippage layer:

| | | |
|---|---|---|
| Polyvinyl butyral resin (S-LEC BX-1 | 3.5 | wt parts |
| Sekisui Kagaku Kogyo) | | |
| Phosphoric acid ester surfactant | 3.0 | wt. parts |
| (PRISURF A208S, Daiichi Kogyo Seiyaku) | | |
| Phosphoric acid ester surfactant | 0.3 | wt. parts |
| (PHOSPHANOL RD720, Toho Kagaku) | | |
| Polyisocyanate (BURNOCK 750-45, | 19.0 | wt parts |
| Dainippon Ink Kagaku Kogyo) | | |
| Talc (Nippon Talc Co., Y/X = 0.03) | 0.2 | wt. parts |
| Methyl ethyl ketone | 35.0 | wt. parts |
| Toluene | 35.0 | wt. parts |

Ink Layer Coating Solution

Next, on the side of the polyethylene terephthalate film opposite the heat-resistant slippage layer, a yellow ink coating solution, a magenta ink coating solution and a cyan ink coating solution to form yellow (Y), magenta (M) and cyan (C) ink layers were each coated sequentially (in face-sequence) by a gravure coating system (dry thickness of 0.8 μm) and dried at 100° C. for 1 min. to form the respective ink layers to obtain thermal transfer sheet 1.

Yellow ink coating solution:

| | | |
|---|---|---|
| Post-chelate dye (Y-1) | 4.5 | wt. parts |
| Polyvinyl acetal resin (S-LEC KX-5 | 5.0 | wt parts |
| Sekisui Kagaku Kogyo) | | |
| Urethane-modified silicone resin | 0.5 | wt. parts |
| (DAIALOMER SP-2105, Dainichiseika Kogyo) | | |
| Methyl ethyl ketone | 45.0 | wt. parts |
| Toluene | 45.0 | wt. parts |

Magenta ink coating solution:

| | | |
|---|---|---|
| Post-chelate dye (M-1) | 4.0 | wt. parts |
| Polyvinyl acetal resin (S-LEC KX-5 | 5.5 | wt parts |
| Sekisui Kagaku Kogyo) | | |
| Urethane-modified silicone resin | 0.5 | wt. parts |
| (DAIALOMER SP-2105, Dainichiseika Kogyo) | | |
| Methyl ethyl ketone | 45.0 | wt. parts |
| Toluene | 45.0 | wt. parts |

Cyan ink coating solution:

| | |
|---|---|
| Post-chelate dye (C-1) | 4.0 wt. parts |
| Polyvinyl acetal resin (S-LEC KX-5 | 5.5 wt parts |
| Sekisui Kagaku Kogyo) | |
| Urethane-modified silicone resin | 0.5 wt. parts |
| (DAIALOMER SP-2105, Dainichiseika Kogyo) | |
| Methyl ethyl ketone | 45.0 wt. parts |
| Toluene | 45.0 wt. parts |

| | |
|---|---|
| Y-1 | 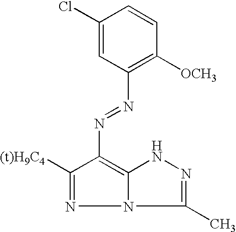 |
| M-1 | 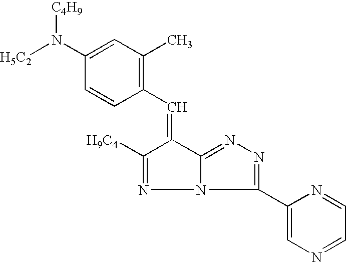 |
| C-1 | 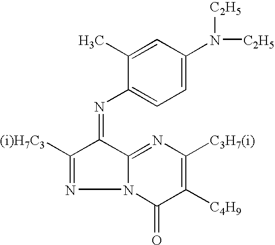 |

### Image Formation

In a thermal transfer recording apparatus installed with a thermal head of a square resistor (80 μm in the main scanning direction×120 μm in the sub-scanning direction) and 300 dpi (dpi: number of dots per inch or 2.54 cm), the image receiving section of the respective thermal transfer image receiving sheets was superimposed onto the ink layer of thermal transfer sheet A or the foregoing thermal transfer ink sheet 1 and set; step pattern patches of yellow, magenta, cyan and neutral (being an overlap of yellow, magenta and cyan colors) were thermally printed from the side opposite the ink layer and the respective dyes were transferred onto the image receiving layer of a thermal transfer sheet to form images 1 to 19.

Further, image 20 was prepared similarly to the foregoing image forming method, provided that a receiving sheet described in Examples of JP-A No. 8-267936 was used as a thermal transfer image receiving sheet.

Thermal transfer sheet A: thermal transfer sheet for use in CAMEDIA p-400 (Olympus Kogaku Kogyo)

### Evaluation of Image

The thus printed images were evaluated according to the following procedure.

Maximum Density

Using a reflection densitometer manufactured by Gretag Macbeth Corp., the printed step pattern patches were measured with respect to maximum reflection density.

Light Fastness

In the printed neutral step pattern patches, the density (D₁) of a step exhibiting a reflection density near 1.2 was measured using a reflection densitometer of Gretag Macbeth and after exposed in a xenon fadometer (at 70,000 lux) for one week, the reflection density (D₂) of the same step was measured. The dye residual ratio was determined according to the following equation, as a measure of light fastness:
Dye residual ratio (%)=[reflection density after exposure (D₂)]/[reflection density before exposure (D₁)]×100

The thus obtained measurement results and evaluation results are shown in Table 2.

TABLE 2

| | | | | | | Light | | | |
|---|---|---|---|---|---|---|---|---|---|
| | | Image | | | | fastness | | | |
| Image | Thermal | Receiving | Maximum Density | | | (residual %) | | | |
| No. | Transfer | Sheet | C | M | Y | C | M | Y | Remark |
| 1 | *A | 1 | 2.10 | 2.05 | 2.18 | 50 | 60 | 80 | Comp. |
| 2 | *A | 2 | 2.15 | 2.10 | 2.21 | 52 | 63 | 82 | Comp. |
| 3 | *A | 3 | 2.14 | 2.08 | 2.18 | 60 | 68 | 85 | Inv. |
| 4 | *A | 4 | 2.13 | 2.09 | 2.19 | 58 | 67 | 85 | Inv. |
| 5 | *A | 5 | 2.15 | 2.11 | 2.22 | 62 | 68 | 86 | Inv. |
| 6 | *A | 6 | 2.14 | 2.10 | 2.21 | 61 | 67 | 84 | Inv. |
| 7 | *A | 7 | 2.14 | 2.08 | 2.20 | 62 | 68 | 84 | Inv. |
| 8 | 1 | 8 | 2.18 | 2.14 | 2.22 | 50 | 65 | 80 | Comp. |
| 9 | 1 | 9 | 2.20 | 2.17 | 2.24 | 52 | 66 | 81 | Comp. |
| 10 | 1 | 10 | 2.21 | 2.17 | 2.24 | 62 | 75 | 85 | Inv. |
| 11 | 1 | 11 | 2.23 | 2.18 | 2.25 | 63 | 76 | 84 | Inv. |
| 12 | 1 | 12 | 2.24 | 2.20 | 2.25 | 65 | 77 | 86 | Inv. |
| 13 | 1 | 13 | 2.20 | 2.18 | 2.24 | 64 | 77 | 87 | Inv. |
| 14 | 1 | 14 | 2.24 | 2.19 | 2.24 | 65 | 78 | 87 | Inv. |
| 15 | 1 | 15 | 2.25 | 2.18 | 2.25 | 65 | 78 | 87 | Inv. |
| 16 | 1 | 16 | 2.23 | 2.18 | 2.24 | 63 | 75 | 85 | Inv. |
| 17 | 1 | 17 | 2.20 | 2.15 | 2.23 | 58 | 76 | 84 | Inv. |
| 18 | 1 | 18 | 2.23 | 2.16 | 2.23 | 57 | 77 | 83 | Inv. |
| 19 | 1 | 19 | 2.18 | 2.12 | 2.21 | 51 | 65 | 80 | Comp. |
| 20 | 1 | *B | 2.16 | 2.08 | 2.18 | 53 | 62 | 84 | Comp. |

*1: Thermal transfer sheet for use in CAMEDIA P-400 (Olympus Kogaku Kogyo)
*2: Image receiving sheet described in Examples of JP-A No. 8-26

As is apparent from the results shown in Table 2, it was proved that the images formed by using a thermal transfer recording material of the invention resulted in sufficiently high image densities and superior light fastness, as compared to comparative samples.

1. A thermal transfer recording material comprising a thermal transfer sheet having a dye layer containing a dye on at least one side of a substrate sheet and an image receiving sheet having a dye receiving layer on at least one side of a substrate and the dye of the dye layer is transferable to the dye receiving layer when the dye layer and the dye receiving layer are superimposed on each other and heated, wherein the dye receiving layer comprises a mold releasing agent and a binder resin and further comprises a metal species selected from the group consisting of an alkaline earth metal(II), B(III), Al(III), Ga(III), Zr(IV), Ag(I), Co(II), Cu(II) and Zn(II).

2. The thermal transfer recording material of claim 1, wherein the metal species is selected from the group consisting of Mg(II), Al (III), Cu(II) and Zn(II).

3. The thermal transfer recording material of claim 1, wherein the metal specie is an organic acid metal salt, a metal alkoxide or an organic metal complex having at least a coordination bond with an oxygen atom.

4. The thermal transfer recording material of claim 3, wherein the metal species is an organic acid metal salt, and the organic acid metal salt being a metal salt of a fatty acid.

5. The thermal transfer recording material of claim 4, wherein the fatty acid has carbon atoms of not more than 18.

6. The thermal transfer recording material of claim 3, wherein a ratio (a/b) of a content “a” (g/m²) of the organic acid metal salt, the metal alkoxide or the organic metal complex to a content “b” (g/m²) of the binder resin is not more than 1.0.

7. The thermal transfer recording material of claim 1, wherein the dye layer contains a dye capable of forming a chelate.

8. The thermal transfer recording material of claim 7, wherein the dye receiving layer further contains a metal ion containing compound capable of forming a chelate compound upon reaction.

9. The thermal transfer recording material of claim 8, wherein a molar ratio of the metal species to the metal ion containing compound is from 0.001 to 0.250.

10. The thermal transfer recording material of claim 1, wherein the metal species meets the following requirement:
4.5≦−logβ≦11
wherein β is an overall stability constant when a metal atom of the metal species and ethylenediamine form a (1:2)-complex at an ionic strength of 0.1 mol/l and 25° C.

11. The thermal transfer recording material of claim 8, wherein the metal ion containing compound meets the following requirement:
10≦−logβ≦20
wherein β is an overall stability constant when a metal atom of the metal ion containing compound and ethylenediamine form a (1:2)-complex at an ionic strength of 0.1 mol/l and 25° C.

12. The thermal transfer recording material of claim 8, wherein the dye receiving layer contains SO₄²⁻, SCN⁻, CH₃COO⁻, F⁻ or Cl⁻.

13. The thermal transfer recording material of claim 8, wherein the metal ion containing compound is represented by the following formula (I):
[M(Q₁)ₓ(Q₂)_{y}(Q₃)_{z}]^{p+}(L⁻)ₚ formula (I)
wherein M is a metal ion; Q₁, Q₂ and Q₃ are each a compound capable of forming a coordination bond with the metal ion of M; L⁻ is an organic anion; x is 1, 2 or 3, y is 0, 1 or 2, z is 0 or 1, and p is 1 or 2.

14. An image forming method of a thermal transfer recording material comprising a thermal transfer sheet having a dye layer containing a dye on at least one side of a substrate sheet and an image receiving sheet having a dye receiving layer on at least one side of a substrate, the method comprising the steps of:
(a) superimposing the dye layer onto the dye receiving layer face, and
(b) imagewise heating the thermal transfer sheet based on an image recording signal to transfer the dye from the thermal transfer sheet to the image receiving sheet,
wherein the dye receiving layer comprises a mold releasing agent and a binder resin and further comprises a metal species selected from the group consisting of an alkaline earth metal(II), B(III), Al(III), Ga(III), Zr(IV), Ag(I), Co(II), Cu(II) and Zn(II).

15. The image forming-method of claim 14, wherein the metal species is selected from the group consisting of Mg(II), Al (III), Cu(II) and Zn(II).

16. The image forming method of claim 14, wherein the metal species is a metal salt of a fatty acid.

17. The image forming method of claim 14, wherein the dye layer contains a dye capable of forming a chelate.
